(19) United States
(12) Patent Application Publication
(10) Pub. No.: US 2008/0229098 A1
(43) Pub. Date: Sep. 18, 2008

(54) ON-LINE TRANSACTION AUTHENTICATION SYSTEM AND METHOD

(75) Inventor: Hanney Ishak, Cairo (EG)

Correspondence Address: LANG MICHENER, BCE PLACE, P.O. BOX 747, SUITE 2500, 181 BAY STREET, TORONTO, ON, M5J 2T7, CA

(73) Assignee: Sips Inc., Toronto (CA)

(21) Appl. No.: 11/612,875

(22) Filed: Mar. 12, 2007

(51) Int. Cl. H04L 9/32

(52) U.S. Cl. 713/156

(57) ABSTRACT

A system and method for authenticating an on-line user by authenticating the computing device being used by the user. The method may comprise reading device information from a computing device, creating a device credential from the device information; and, communicating the device credential to an authenticating body for authentication. The method may additionally comprise receiving personal information from a user; creating a user credential from the personal information and, communicating the user credential along with the device credential to the authenticating body for authentication.

### FIELD OF THE INVENTION

The present invention relates to a system and method for authenticating on-line transactions. In particular, the present invention relates to an on-line transaction authentication method which confirms a user's identity by authenticating the computing device used by the user.

### BACKGROUND OF THE INVENTION

Authenticating the identity of on-line parties is a difficult task as it is difficult to physically identify a party, and relatively simple for an unscrupulous party to assume alternate identities. One area that remains problematic is ensuring the identity of a user when an on-line transaction is made.

Fraud may occur by an unscrupulous party maintaining multiple identities. In this manner an on-line merchant may repeatedly deal with the unscrupulous party, each time believing that they are dealing with a different third party. The unscrupulous party may carry out this deception by assuming alternate innocent party identities, or manufacture multiple fictitious identities in order to carry out the fraud.

The standard authentication mechanism used on-line is to identify a user with a public identifier, such as a username, and a private confirmation, a password. The advantage of this arrangement is that the user is able to buy goods on-line in the same manner as if they were shopping in person at a “bricks-and-mortar” retail store.

The disadvantage is that transactions on-line are not completely secure, and the credit card information and authenticating information can be captured by a third party and used to make fraudulent transactions. Additionally, ‘spyware’ or ‘malware’ that is loaded onto a user's computing device can capture keystroke information, and transmit to an unscrupulous third party the credit card and user information. Once a username and password are compromised, there is no way of verifying the physical identity of an entity entering the username and password. Thus the transaction becomes susceptible to abuse by unscrupulous individuals either stealing innocent third party usernames and passwords, or creating multiple fictitious usernames and passwords.

In order to authenticate an on-line transaction, it has been recognised that on-line entities need to establish a secondary measure of trust to accompany an individual's username and password.

One method used to establish a secondary method of trust is the VeriSign™ system. When the user makes an on-line purchase and enters their credit card information at the merchant's on-line website, a VeriSign™ browser window pops up requesting secondary authentication. The user is then asked to enter secondary authentication information into the pop-up to verify the transaction. While this system establishes a secondary measure of trust and addresses fraud relating to that particular transaction, the secondary authentication information only identifies the bank card, and not the individual using the card.

Another method used to establish a secondary method of trust is to monitor a user's on-line behaviour patterns to determine when it is necessary to block or challenge a transaction. Such a system has been introduced by Corrillian (www.Corillian.com) and is known as Intelligent Authentication™. The Corrillian method identifies transactions that differ from a pattern built up of time. This method requires enough on-line transactions to create a pattern and the use of a central monitoring body that tracks a user's on-line activities. Furthermore, the method is unsuitable for authenticating a regular user such as a user at a particular registered site where they hold an account.

Alternatively, a system offered by Passmark Security (www.PassmarkSecurity.com) installs a software tag that is embedded into a user's device on initial signup. An independent trusted third party (i.e. Passmark Security) runs an authentication server that keeps a record of the tag assigned to each individual. An online merchant may then contact the third party with a user's tag to confirm the identity of the user with the authority. The Passmark method can identify a tagged device as having been authenticated with a particular user. The main drawbacks are that it relies upon a central authenticating body to authenticate the device and the embedding of a tag on a user's device. Users are typically reluctant to allow a third party to embed tags on their devices that they cannot easily remove. Additionally, no attempt is made to authenticate individual transactions. A further difficulty is that it is sometimes difficult to securely embed a software tag on a computer, making it possible that a tag may be removed or altered by a user. Unscrupulous parties could remove the tag and re-register to obtain a new tag in order to carry out fraudulent transactions.

All of these methods rely upon contacting a central trusted third party being involved in each transaction. The necessity of contacting a third party for every transaction is time consuming and adds considerable overhead to the legitimate transactions which constitute the majority of on-line transactions. Furthermore, some on-line transactions, such as logging onto an on-line gaming site, do not require payment verification but instead only require the positive identification of the user. For these applications it may not be practical to employ a third party authentication process.

An additional limitation with relying on embedding a software tag is that it may not be possible to embed a secure software tag on some Internet-enabled devices. These devices, such as a mobile communications device or on-line gaming device, are likely to be used with greater frequency in on-line applications where identification of a user is desired.

Accordingly, there remains a need for a secure on-line authentication system which provides a secure secondary measure of trust in on-line transactions.

Additionally, there remains a need for a secure on-line authentication system that does not require the writing of secure data to an accessing device.

There further remains a need for a method that allows an on-line entity to have some measure of assurance of the physical identity of the party contacting it; Preferably this method would augment the current user authentication method of a username and password.

There also remains a need for method to prevent an unscrupulous party from maintaining multiple false identities from their computing device.

There remains a further need for an on-line authentication method that may be used to authenticate a user with the aid of a central trusted third parties for some transactions and without the central party for other transactions.

### BRIEF DESCRIPTION OF THE DRAWINGS

The present invention will be described, by way of example only, with reference to the accompanying drawings, in which:

FIG. 1 is schematic view of an on-line transaction, depicting the communication paths between a user, an on-line merchant and a financial institution;

FIG. 2 is a schematic view of the communication paths of the authentication system of the present invention;

FIG. 3a is a flowchart depicting the steps of the registration phase of the authentication system of the present invention; and

FIG. 3b is a flowchart depicting the steps of authenticating an on-line transaction according to an embodiment of the present invention.

### DETAILED DESCRIPTION OF THE INVENTION

In a first embodiment the present invention provides a method for confirming the identity of an on-line user, the method comprising: reading device information from a computing device; creating a device credential from the device information; and, communicating the device credential to an authenticating body for authentication.

The method may further comprise: receiving personal information from a user; creating a user credential from the personal information and, communicating the user credential along with the device credential to the authenticating body for authentication.

Alternatively, the method may further comprise: creating an authentication certificate from at least the device credential and the device credential is communicated to the authenticating body by communicating the authentication certificate.

In a further embodiment, the present invention provides a method for authenticating the identity of a user using an on-line computing device, the method comprising: receiving a device credential from the computing device; comparing the device credential with stored device information associated with the user; and, authenticating the user's identity if the device credential matches the stored device information.

In an additional embodiment, the present invention provides a method for authenticating the identity of a user using an on-line computing device, the method comprising: receiving a device credential from the computing device; comparing the device credential with stored device information associated with the user; comparing the device credential with a device black-list of device information, whereby if the device credential matches device information on the device black-list, not authenticating the user and authenticating the user's identity if both the device credential does not match device information on the device black-list and the device credential matches the stored device information.

The present invention provides for a system for authenticating a user's identity in an on-line transaction, the system comprising: an authenticating body for authenticating on-line transactions; a computing device for use in conducting on-line transactions, the computing device being programmed to read device information from the computing device and to receive personal information from the user, and to communicate a user credential comprised from the personal information and a device credential comprised from the device information to the authenticating body; a user database accessible by the authenticating body for storing and retrieving device information associated with the user's personal information; whereby the authenticating body authenticates the transaction by comparing the received user credential with the stored personal information to identify the user and comparing the received device credential with the stored device information associated with the identified user.

The present invention is directed towards a method of providing a secure secondary measure of trust in on-line transactions. One particular transaction that will be discussed below is on-line payment for goods or services using a financial institution account such as a bank account or credit account. While the present invention is discussed in terms of this particular application, the person skilled in the art will appreciate that the present invention is applicable to a broad range of on-line uses, whenever it is desired to securely identify a user. Typical uses would include, without limitation: purchases, bill payment, account login, site logon (gaming, or other secure site access), VPN or Telnet access, and other on-line activities that require identification of a user. The method may also be used multiple times within the context of a single on-line transaction: at initial registration (to determine “black-listed” computers), at time of logon (by a registered user), at the time of transaction (to authenticate a user and their financial information) and after transaction for transactional evidence that the user's device was involved in the transaction. While initially discussed in terms of a financial transaction, some of these other uses will be described in more detail below.

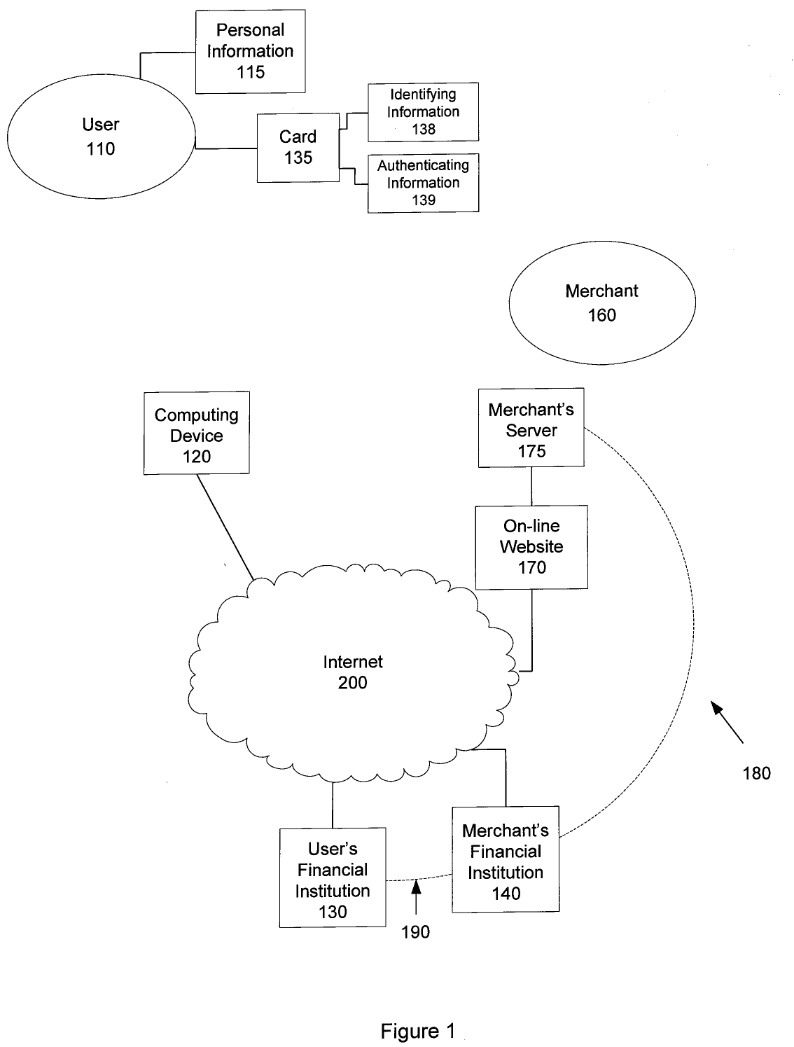

FIG. 1 illustrates a typical on-line transaction, comprising a user 110 in possession of a financial institution financial account that the user 110 has opened with the user's financial institution 130. Typically, the user's financial institution 130 will issue a financial institution card 135 to identify the financial institution account. As will be evident to the skilled worker in the art, while a financial institution card 135 is often a part of payment in on-line transactions, it is not necessary for the user in an on-line transaction to physically possess an actual financial institution card 135. Alternatively the financial institution 130 could identify a financial account solely by way of an identifier such as an account number.

The user 110 has personal identifying information 115, such as a birth date, home address or telephone number. The financial institution card 135 also has card identifying information 138, and card authenticating information 139, such as an expiry date, PIN, password or authentication number, or a combination thereof. The card identifying information 138 is typically visible on the financial institution card 135, while card authentication information 139 may either be visible, such as the expiry date or cardholder name, or alternatively may comprise a secret known only to the user's financial institution 130 and the user 110, such as a PIN or password. Generally, financial institutions rely upon a combination of card identifying information 138 and at least two pieces of card authentication information 139, such as an expiry date and security code.

The user 110 engages in an on-line transaction by browsing a computer network, for example the Internet 200, on a web-enabled computing device 120, such as a PC, handheld processing device or web-enabled phone, for instance. The computing device 120 is typically made up of discrete hardware components on which an operating system and software is stored. The hardware components preferably have identifiers such as serial numbers associated with them that are accessible by software running on the computing device 120. Similarly, the software and operating system stored and potentially running on the computing device 120 have identifiers associated with them that are accessible by software running on the computing device 120. Typically, some of the identifiers are unique to that particular computing device 120, while other identifiers may be common to other computing devices.

The user 110 browses to the on-line website 170 of a merchant 160, who provides a user interface for the transaction in which the user 110 selects goods or services they wish to purchase and then selects a payment method, for example by a financial institution card. In this example, the financial institution card 135 is a credit card. The merchant's website 170 then asks the user 110 to enter payment information. The user 110 submits the card identifying information 138 and card authentication information 139 to the merchant 160. The merchant 160 forwards the user's information and transaction amount to a financial institution for authorisation.

The financial institution could be the user's financial institution 130, or alternatively, it could be the merchant's financial institution 140. If the latter, the merchant's financial institution 140 would forward the transaction details to the user's financial institution 130 for authorisation. Communications between the merchant's server 175 and the merchant's financial institution 140 may occur either through a global computer network such as the Internet 200, or through a separate secure link 180. Typically communications between financial institutions occurs over a secure network 190.

After the merchant 160 receives confirmation from the user's financial institution 130, the transaction is confirmed with the user 110. In this manner a typical on-line transaction is carried out with a user 110 identifying himself/herself through use of card information 138, and possibly personal information 115.

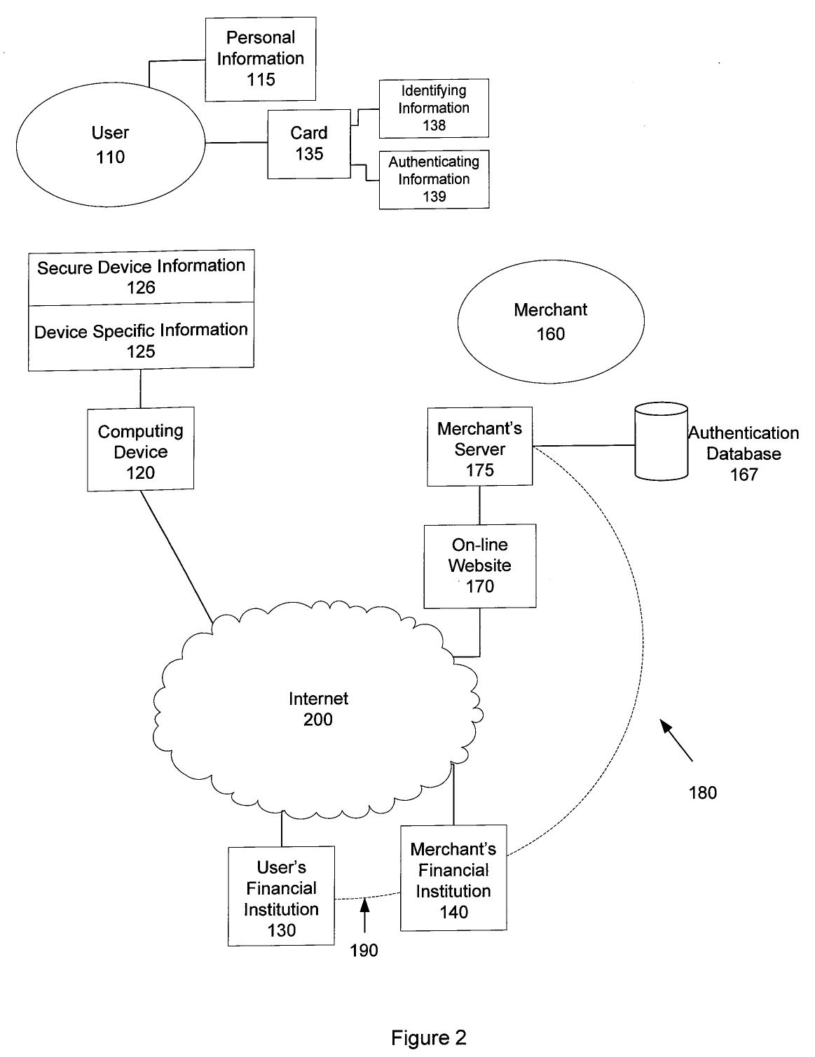

FIG. 2 illustrates an e-commerce transaction carried out according to an embodiment of the present invention. In the embodiment, the user 110 must first register the computing device 120 with an authenticating body. The authenticating body may be the merchant 160, the user's financial institution 130, or a trusted third party (not shown). In the embodiment illustrated in FIG. 2, the authenticating body is the merchant 160.

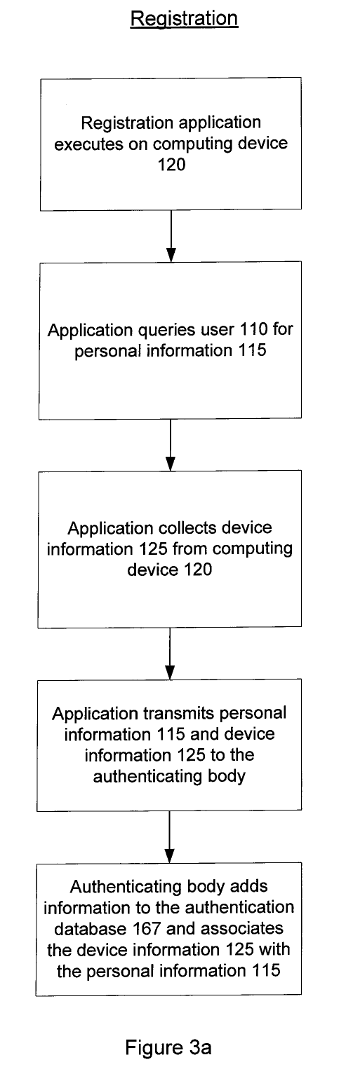

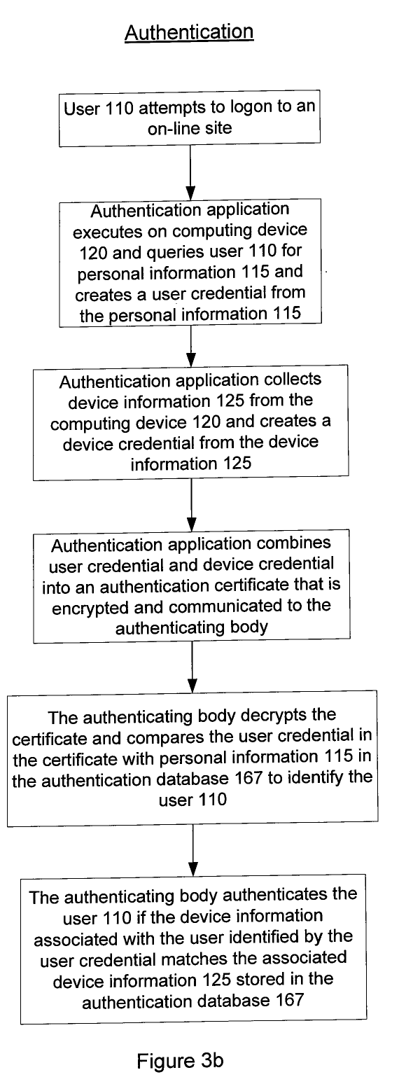

To carry out the registration, the user 110 executes a registration application on the computing device 120 as illustrated in FIG. 3a. The registration application may be a software component downloaded from a website, such as an applet, ActiveX control, downloadable application or script, or alternatively may be software delivered to the user 110 on a physical medium, such as a CD. In either case, the registration application authenticates the computing device 120. The registration application retrieves hardware and/or software identifiers from the computing device 120 that comprise device specific information 125 such as hard disk information, operating system details, manufacturer details, processor details, BIOS information, networking information, IP address and ISP server address, and any other information or combination thereof that would help to identify the computing device 120, preferably including at least one piece of secure device specific information 126 that uniquely identifies a fixed hardware/software component such as the BIOS, motherboard serial number, operating system serial number and installation date, or the like. In a preferred embodiment, the secure device specific information 126 comprises a combination of two or more fixed hardware or software identifiers. The collection of identifiers that comprise the device specific information 125 uniquely identify the computing device 120.

The registration application then transmits the device information 125 to the authenticating body. In this example the authenticating body is the merchant 160. In addition to the device information 125, the user 110 is asked to provide personal information 115 to complete the registration process. The authenticating body stores the device information 125 and the personal information 115 in a database 167 and associates the device information 125 with the personal information 115. If the personal information 115 matches with a previous entry, the device information 125 may be added to the prior entry as an alternate computing device 120 used by that user 110. The authenticating body may also associate the user's personal information 115 with a username and password as is known in the art to simplify user authentication in future transactions. In such a manner, the user 110 may be authenticated by both user identifying information, the username and password and device identifying information, the device information 125.

At this time, preferably, the authentication body compares the personal information 115 and device information 125 against prior user information stored in the database 167, as well as a device black-list of black-listed device information and a user black-list of black-listed user information. If the user information 115 or device information 125 matches the black-listed user information or black-listed device information, then the registration attempt is declined. If only one of the black-listed user information or black-listed device information is present in the black-list, then the other of the user information 115 or device information 125 may be added to the black-list.

The step of updating the black-list is useful to prevent unscrupulous individuals from recycling false user information with new devices, or supplying new false user information with devices that have previously been registered with the authentication.

After successful registration, the user 110 may proceed to conduct an e-commerce transaction, by browsing the website 170 and selecting goods and/or services to purchase. In order to complete the transaction, user 110 must enter personal information into the user interface provided by the merchant's website.

When the user 110 accesses the user interface to process a transaction, the authentication application is initiated at the time of the transaction to authenticate the computing device 120 as illustrated in FIG. 3b. The authentication application may use some or all of the personal information 115 and device information 125 to create a user credential and a device credential that serves to authenticate the user 110 and the computing device 120 respectively. As will be appreciated, the user credential may comprise a username and password if the user 110 has previously registered with the authenticating body. The authentication application may create a unique authentication certificate for the specific transaction comprising transaction information, the user credential and the device credential. Optionally, the authentication certificate may additionally comprise card identifying information 138 and/or card authenticating information 139. In an alternative embodiment, the authentication certificate comprises only the user credential and the device credential. This alternate embodiment would typically be employed where the authenticating body is authenticating the user 110 separate from the financial transaction approval process, and does not need the transaction details for the authentication. It will be apparent that in situations where a user has submitted user identifying information to the on-line site, the authentication certificate may be comprised solely of the device credential, as the user may be identified by the user identifying information submitted separately.

The authentication application then transmits the authentication certificate, or authentication certificate and separate user identifying information, or authentication certificate, personal information 115 and card information 138, from the computing device 120 to the authenticating body, such as the on-line website 170. In the latter embodiment, the merchant's server 175 reads the authentication certificate to verify the user 110 and computing device 120.

It will be appreciated that to create the user credential and the device credential the actual user personal information, card information and/or device information 125 may be used, or a part of each may be used, or a hash or other values derived from these data sources may be used. Alternatively a proxy, such as an account number, user number or unique authentication phrase may be used to associate a user with a registered device. The authentication certificate is preferably secure such that only the authentication application is able to create the secure transaction certificates and only the authenticating body is able to read the secure authentication certificates. A certificate may be secured by encryption, a hash function, transformation or other operation, improve the security of the secure transaction certificate. The secure authentication certificate may then be forwarded to the authenticating body.

As mentioned above, the authentication certificate may optionally be comprised of only a device credential, while the personal information 115, card identifying information 138, card authentication information 139 or transaction information is submitted separately. This embodiment would be useful, for instance, where the authenticating body is not the financial institution 130. For instance, where the authenticating body is the merchant or a third party, the validity of the device identity could be confirmed in the context of the personal information 115 submitted by the user before the merchant completes the transaction using the personal information 115 and card information 138.

In either case, the authenticating body reads the transaction certificate sent by the application and verifies that the computing device 120 has been registered for use by the user 110. The authenticating body verifies the computing device 120 by comparing the device credential in the transaction certificate with its database of registered devices. The authenticating body preferably also compares the device credential with the device black-list kept by the authenticating body to identify computing devices that have been previously identified as attempting unauthorized transactions. The use of the device black-list allows the authenticating body to prevent fraud by unscrupulous individuals. While it is a relatively simple matter to generate false personal information, it is difficult to replicate unique device specific information.

Since the unscrupulous individual does not know which device information 125 will be extracted by the application, it is difficult for the unscrupulous individual to submit false information to the authenticating body. In order to carry out repeated fraudulent transactions, the individual would either need to employ a new computing device 120 for each transaction, or break the authentication application to send a spurious transaction certificate.

The unscrupulous individual would have to create a software program that duplicated the operation of the application, but submitted false numbers to the authentication on registration. Replication of a false application would be difficult to implement since the application is run at the time of registration in direct communication with the authentication body. Methods of authenticating the source and validity of executable software are known in the art. For instance, the authenticating body may verify the veracity of the application through digital signatures, hashing, encrypted keys or other known authentication means.

As an additional safeguard, the information collected by the application and the treatment of the collected information could change with every implementation of the application. Since only the authenticating body and the application would know both which data is to be collected and how the data is to be secured, it would be extremely difficult for the unscrupulous individual to submit false information. In a preferred embodiment, the application is a downloadable application that is downloaded from the Internet each time a transaction is carried out using the computing device 120. In this way, the application and the transaction certificate benefit from additional security since the method of authentication may change with each implementation. Moreover, since the time of downloading the application is known to the provider, a window of validity may be set in which the downloaded application is valid. If an unscrupulous individual is able to break that application, they would have only a short amount of time in which to do so before the window expired.

Upon authentication of the user 110, the merchant's server 175 forwards the card number, authentication information and transaction information to the financial institution 130. The information may either be forwarded directly to financial institution 130, or the information may be sent to the merchant's own financial institution 140 to be forwarded to the user's financial institution 130. These communications may either take place over a global computer network such as the Internet 200, or optionally via a secure communications link 180 connecting the merchant's server 175 to the merchant's financial institution 140 and a secure communications network 190 connecting the merchant's financial institution 140 to the user's financial institution 130, or by other communication means known in the art.

Thus, the transaction is authenticated by identifying the identity of a user, and authenticating the identity based upon both user-specific authentication comprising a user credential and device-specific authentication comprising a device credential.

In an alternate embodiment of the present invention, the device credential contained within the authentication certificate may be used to uniquely identify the computing device 120 in the event the transaction is not authorized by the user's financial institution 130. In such circumstances the device information 125 of the computing device 120 may be ‘black-listed’ by the authenticating body, such as the merchant's server 175, to prevent future unauthorized transactions. Alternatively the “black-list” could be maintained by a trusted third party such as an ISP or security provider. Thus, if the computing device 120 is used for a series of transactions where the authentication information is invalid, a subsequent transaction employing the expected authentication information will not be allowed as the prior unauthorized transactions indicate that the computing device 120 is not secure.

Similarly, the present invention may be used within the context of on-line registration wherein a user registers on-line and the authentication application creates a secure registration certificate comprised of device information and registration information. The secure registration certificate is sent to the merchant's server 175 for verification. In this context verification would include both comparison with black-listed device information, as well as comparing the device identifier with previous device identifiers recorded during registration. In the event a user was attempting multiple registrations using the same computer, the merchant's server 175 (or financial institution) could block subsequent registration attempts. This embodiment of the present invention has particular application in prevention of credit card fraud where an unscrupulous individual obtains an innocent party's personal information and attempts to conduct multiple on-line registrations from the same computing device 120. A computing device 120 that attempted such multiple registrations could be added to a “black-list” to prevent future fraudulent acts.

In an alternate embodiment, the present invention may be employed in the context of secure access in situations such as on-line gaming or VPN/Telnet access. In this embodiment the authentication application creates a secure transaction certificate that comprises log-on information, device specific information 125 and optionally personal information 115.

A user seeking on-line access, for instance to an on-line gaming site or VPN/Telnet access, connects to the site or server. The first time the user seeks access, the user and computing device 120 are registered by executing the registration application to extract device specific information 125 from the computing device 120. The authenticating body, either the on-line site or a trusted third party, stores the device specific information 125 in a database 167 associated with the personal information 115 for that user 110. The next time the user logs onto the site, the authentication application may be executed to create a device credential for authentication by the authentication body. As described above, the authentication application may be automatically downloaded from the on-line site when the user enters login information, such as a user id and password, so that the authentication process is transparent to the user. In this fashion a user's identity may be authenticated by both a user credential, such as the user id and password, and a device credential.

In the event a user 110 uses multiple computing devices 120 to perform on-line transactions, each of the computing devices 120 may be registered with the authenticating body and associated with that user.

In an alternate embodiment, a user may be identified solely by the device information 125. This alternate embodiment would be useful, for instance, of the current relatively insecure cookie method of identifying a user and computing device. The alternate embodiment would rely solely on the identity of the computing device to gain access to a secure website, as opposed to the current methods of a username, username and password, or cookie to identify an authorized user.

Preferred embodiments of the invention have been thus described by way of example only. It will be appreciated by those skilled in the art that variations and modifications may be made without departing from the scope of the invention as defined by the claims.

We claim:

1. A method for confirming the identity of an on-line user, the method comprising:
reading device information from a computing device;
creating a device credential from the device information; and,
communicating the device credential to an authenticating body for authentication.

2. The method of claim 1 further comprising:
receiving personal information from a user;
creating a user credential from the personal information and,
communicating the user credential along with the device credential to the authenticating body for authentication.

3. The method of claim 1 wherein an authentication certificate is created from at least the device credential and the device credential is communicated to the authenticating body by communicating the authentication certificate.

4. The method of claim 3 wherein the authentication certificate further comprises a user credential comprised of personal information collected from the user.

5. The method of claim 3 wherein the authentication certificate is first encrypted and then communicated to the authenticating body.

6. A method for authenticating the identity of a user using an on-line computing device, the method comprising:
receiving a device credential from the computing device;
comparing the device credential with stored device information associated with the user; and,
authenticating the user's identity if the device credential matches the stored device information.

7. The method of claim 6 wherein a user credential is received along with the device credential, the user credential identifying the stored device information to be compared.

8. The method of claim 7 wherein the user credential and the device credential are received in the form of an encrypted authentication certificate.

9. The method of claim 6, the method further comprising:
comparing the device credential with a device black-list of device information,
whereby if the device credential matches device information on the device black-list, not authenticating the user.

10. The method of claim 7, the method further comprising:
comparing the device credential with a device black-list of device information;
comparing the user credential with a user black-list of user information;
whereby if either the device credential matches device information on the device black-list, or the user credential matches user information on the user black-list, not authenticating the user.

11. The method of claim 10 wherein if the user is not authenticated, updating the user black-list and the device black-list to include either of the device credential or the user credential that are not on the black-lists.

12. A system for authenticating a user's identity in an on-line transaction, the system comprising:
an authenticating body for authenticating on-line transactions;
a computing device for use in conducting on-line transactions, the computing device being programmed to read device information from the computing device and to receive personal information from the user, and to communicate a user credential comprised from the personal information and a device credential comprised from the device information to the authenticating body;
a user database accessible by the authenticating body for storing and retrieving device information associated with the user's personal information;
whereby the authenticating body authenticates the transaction by comparing the received user credential with the stored personal information to identify the user and comparing the received device credential with the stored device information associated with the identified user.
